(19) United States
(12) Patent Application Publication
(10) Pub. No.: US 2023/0399512 A1
(43) Pub. Date: Dec. 14, 2023

(54) THERMALLY CONDUCTIVE COMPOSITION

(71) Applicant: Resonac Corporation, Tokyo (JP)

(72) Inventors: Hajime FUNAHASHI, Tokyo (JP); Hikaru SATOH, Tokyo (JP); Hajime YUKUTAKE, Tokyo (JP); Ikue KOBAYASHI, Tokyo (JP); Takeshi IEMURA, Tokyo (JP)

(73) Assignee: Resonac Corporation, Tokyo (JP)

(21) Appl. No.: 18/127,704

(22) Filed: Mar. 29, 2023

(30) Foreign Application Priority Data
Mar. 30, 2022 (JP) 2022-056777

(51) Int. Cl. C08L 83/04; C08K 3/28; C08K 5/14; C08K 9/06

(52) U.S. Cl. CPC C08L 83/04; C08K 3/28; C08K 5/14; C08K 2201/014; C08K 2003/282; C08K 2201/001; C08K 9/06

(57) ABSTRACT

A thermally conductive composition contains a resin composition and a thermally conductive filler, wherein the resin composition contains a vinyl group-containing silicone resin having a viscosity ranging from 40,000 mPa·s to 200,000,000 mPa·s at 25° C. and a polysiloxane compound having at least one hydroxy group at an end, having no vinyl group, and having a weight-average molecular weight (Mw) of 10,000 or more and 20,000 or less, the mass ratio of the vinyl group-containing silicone resin to the polysiloxane compound [the vinyl group-containing silicone resin/the polysiloxane compound] is 50/50 or more and less than 90/10, the content of the thermally conductive filler ranges from 300 parts by mass to 5,000 parts by mass with respect to 100 parts by mass of the resin composition, and a cured product of the thermally conductive composition has a thermal conductivity of 1.0 W/mk or more.

### Field of the Invention

The present invention relates to a thermally conductive composition.

### BACKGROUND OF THE INVENTION

The removal of heat from heating elements has been a problem in various fields in recent years. The removal of heat from particularly exothermic electronic devices such as electronic instruments, personal computers, automotive engine control units (ECUs) and batteries is an important problem. The heating value of an exothermic part has been recently increased and thus a heat dissipation material with high thermal conductivity has been used as a countermeasure against heat.

Examples of a heat dissipation material that is in use include shaping materials such as a heat dissipation sheet produced by adding a thermally conductive filler to an elastomer, and casting materials such as a material referred to as a potting material having thermal conductivity enhanced by the addition of a thermally conductive filler to a silicone material. These materials have relatively high thermal conductivity, and the use of these materials enables to miniaturize a heat dissipator and enables to reduce the size and weight of an electronic device, so that these materials are actively used. However, due to increases in heating values of heating elements in recent years, a heat dissipation material with even higher thermal conductivity is required.

Various techniques have been conventionally proposed to solve these problems. For example, PTL1 proposes a thermally conductive silicone composition containing organopolysiloxane as a base polymer and thermally conductive fillers, in which alumina surface-treated with a silicone having an alkoxy group at one end and an aluminum nitride are used in combination, and a cured product thereof. Further, PTL1 demonstrates that the thermally conductive silicone composition has thermal conductivity as high as 5 W/mk, and proposes a heat dissipation material containing a vinyl group-containing silicone resin.

### CITATION LIST

### Patent Literature

PTL1: Japanese Patent Laid-Open No. 2017-210518

### SUMMARY OF THE INVENTION

A heat dissipation material is required to have high thermal conductivity and to exhibit low viscosity immediately after production in view of workability at the time of shaping and casting, etc. Further, from the same viewpoint, a heat dissipation material is desired to have an appropriate reaction rate, and excellent storability. Furthermore, the cured product of a heat dissipation material is required to be not too hard and have appropriate hardness, so as to avoid applying a load to a substrate, a heater element, etc., to the extent possible.

Further, the use of a vinyl group-containing silicone resin and an organic peroxide as components of a heat dissipation material has been problematic in that the vinyl group-containing silicone resin is foamed during production of the heat dissipation material and the resin in such a foamed state is cured to have poor appearance. The use of the same has also been problematic in that a resin such as a vinyl group-containing silicone resin and a thermally conductive filler cannot be uniformly mixed (the resin cannot be uniformly filled with the thermally conductive filler), and thus a heat dissipation material that can be a cured product having appropriate hardness may not be obtained.

The present invention has been made in view of such circumstances, and an object thereof is to provide a thermally conductive composition having high thermal conductivity, exhibiting low viscosity immediately after production, and making it possible to obtain a cured product having appropriate hardness and good appearance.

As a result of diligent studies in order to solve the above problems, the inventors have found that the problems can be solved by the invention below.

Specifically, the present disclosure relates to:

[1] A thermally conductive composition containing a resin composition and a thermally conductive filler, wherein
the resin composition contains a vinyl group-containing silicone resin having a viscosity ranging from 40,000 mPa·s to 200,000,000 mPa·s at 25° C. as measured according to JIS Z8803:2011 and a polysiloxane compound having at least one hydroxy group at an end, having no vinyl group, and having a weight-average molecular weight (Mw) in terms of polystyrene of 10,000 or more and 20,000 or less as measured by gel permeation chromatography (GPC),
the mass ratio of the vinyl group-containing silicone resin to the polysiloxane compound [the vinyl group-containing silicone resin/the polysiloxane compound] is 50/50 or more and less than 90/10,
the content of the thermally conductive filler ranges from 300 parts by mass to 5,000 parts by mass with respect to 100 parts by mass of the resin composition, and
a cured product of the thermally conductive composition has a thermal conductivity of 1.0 W/mk or more as measured according to IS022007-2.
   [2] The thermally conductive composition according to [1] above, wherein the polysiloxane compound has two or more hydroxy groups, at one of the ends of the main chain constituting the polysiloxane compound.
   [3] The thermally conductive composition according to [1] or [2] above, containing an organic peroxide.

The thermally conductive composition according to any one of claims 1 to 3, wherein the polysiloxane compound is represented by general formula (2) below:

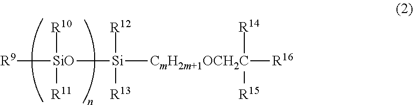

wherein R⁹ is an alkyl group having 1 to 18 carbon atoms or a phenyl group, R to R¹³ are each independently an alkyl group having 1 to 18 carbon atoms or a phenyl group, R¹⁴ and R¹⁵ are each independently a hydrogen atom, a hydroxymethyl group, or a hydroxyethyl group, R¹⁶ is an alkyl group having 1 to 3 carbon atoms, a hydroxy group, or a phenyl group, n is 5 to 250 and m is an integer of 1 to 20, and when there are a plurality of R¹⁰ and R¹¹ above, the plurality of R and R¹¹ are the same or different.
[5] The thermally conductive composition according to [4] above, wherein R⁹ is an alkyl group having 1 to 18 carbon atoms.
[6] The thermally conductive composition according to [4] or [5] above, wherein R¹⁴ and R¹⁵ above are each independently a hydroxymethyl group or a hydroxyethyl group.
[7] The thermally conductive composition according to any one of [1] to [6] above, wherein the content of the thermally conductive filler is 4,000 parts by mass or less with respect to 100 parts by mass of the resin composition.
[8] The thermally conductive composition according to any one of [1] to [7] above, wherein the vinyl group-containing silicone resin has a viscosity of 20,000,000 mPa·s or less at 25° C. as measured according to JIS Z8803:2011.
The thermally conductive composition according to any one of [1]to [8] above, which is used for a heater element.

### Advantageous Effect of Invention

According to the present invention, a thermally conductive composition having high thermal conductivity, exhibiting low viscosity immediately after production, and making it possible to obtain a cured product having appropriate hardness can be provided.

### DETAILED DESCRIPTION OF THE INVENTION

The terms and notation used herein are as defined below.

The term “viscosity of a vinyl group-containing silicone resin at 25° C.” refers to a value measured according to JIS Z8803:2011 using a rotational viscometer (for example, available from Toki Sangyo Co., Ltd, product name: TVB-10, rotor No. 3) under conditions of a rotational speed of 20 rpm.

The expression “polysiloxane compound having at least one hydroxy group at an end” refers to a compound having at least one hydroxy group at one of the ends of the main chain constituting the polysiloxane compound, or a compound having at least one hydroxy group at each of both ends of the main chain constituting the polysiloxane compound.

The term “weight-average molecular weight (Mw) of the polysiloxane compound” refers to a weight-average molecular weight in terms of polystyrene as measured by gel permeation chromatography (GPC).

The term “thermal conductivity of a cured product of the thermally conductive composition” refers to a value measured according to ISO22007-2 using a hot-disk method and a thermophysical property measuring device (available from Kyoto Electronics Manufacturing Co., Ltd., product name TPS 2500 S).

Regarding preferable numerical ranges (for example, the range of content, etc.), lower limits and upper limits described in stages can be each independently combined. For example, based on a description, “preferably 10 to 90, more preferably 30 to 60”, “preferable lower limit (10)” and “more preferable upper limit (60)” can also be combined to be “10 to 60”.

The term “viscosity immediately after production of the thermally conductive composition” refers to viscosity for up to 5 minutes after production of the thermally conductive composition.

### [Thermally Conductive Composition]

The thermally conductive composition of this embodiment is a thermally conductive composition containing a resin composition and a thermally conductive filler, wherein the resin composition contains a vinyl group-containing silicone resin having a viscosity ranging from 40,000 mPa·s to 200,000,000 mPa·s at 25° C. as measured according to JIS Z8803:2011, and a polysiloxane compound having at least one hydroxy group at an end, having no vinyl group, and having a weight-average molecular weight (Mw) in terms of polystyrene of 10,000 or more and 20,000 or less as measured by gel permeation chromatography (GPC), and the mass ratio of the vinyl group-containing silicone resin to the polysiloxane compound [the vinyl group-containing silicone resin/the polysiloxane compound] is 50/50 or more and less than 90/10. Moreover, the content of the thermally conductive filler ranges from 300 parts by mass to 5,000 parts by mass with respect to 100 parts by mass of the resin composition, and a cured product of the thermally conductive composition has a thermal conductivity of 1.0 W/mk or more as measured according to ISO22007-2.

The thermally conductive composition of this embodiment contains a resin composition containing the predetermined vinyl group-containing silicone resin and the predetermined polysiloxane compound, so that a thermally conductive composition exhibiting low viscosity immediately after production can be produced without foaming at the time of production, and a cured product having appropriate hardness and good appearance can be obtained.

### <Resin Composition>

The resin composition of this embodiment contains a vinyl group-containing silicone resin having a viscosity ranging from 40,000 mPa·s to 200,000,000 mPa·s at 25° C. as measured according to JIS Z8803:2011, and a polysiloxane compound having at least one hydroxy group at an end, having no vinyl group, and having a weight-average molecular weight (Mw) in terms of polystyrene of 10,000 or more and 20,000 or less as measured by gel permeation chromatography (GPC). Moreover, the mass ratio of the vinyl group-containing silicone resin to the polysiloxane compound [the vinyl group-containing silicone resin/the polysiloxane compound] is 50/50 or more and less than 90/10.

The content of the resin composition in the thermally conductive composition of this embodiment is preferably 1.0 mass % or more and 30.0 mass % or less, more preferably 2.0 mass % or more and 20.0 mass % or less, and further preferably 3 mass % or more and 15 mass % or less with respect to the total amount of the thermally conductive composition. If the content of the vinyl group-containing silicone resin is 1.0 mass % or more, thermally conductive filler can be mixed with a liquid resin by kneading, and if the content of the liquid silicone resin is 30.0 mass % or less, high heat conduction performance can be imparted.

### (Vinyl Group-containing Silicone Resin)

The vinyl group-containing silicone resin to be used in this embodiment contains a vinyl group and has a viscosity ranging from 40,000 mPa·s to 200,000,000 mPa·s at 25° C. as measured according to JIS Z8803:2011. Here, the term “vinyl group-containing silicone resin used in this embodiment” refers to a silicone resin that is liquid or has flowability at room temperature (25° C.).

The vinyl group-containing silicone resin having a viscosity of 40,000 mPa·s or more is excellent in thermal stability, and the same having a viscosity of 200,000,000 mPa·s or less can be filled to a high degree with a thermally conductive filler. From such a viewpoint, the viscosity ranges from preferably 42,000 mPa·s to 20,000,000 mPa·s, more preferably 42,000 mPa·s to 10,000,000 mPa·s, and further preferably 45,000 mPa·s to 5,000,000 mPa·s.

The vinyl group-containing silicone resin is a resin resulting from a process such that a radical generated from a cross-linking agent, organic peroxide, withdraws a hydrogen of a Si—CH₃ group of a vinyl group-containing silicone resin, and then the thus generated Si—CH₂ radicals bind to each other to proceed a crosslinking reaction.

Examples of the vinyl group-containing silicone resin include an organopolysiloxane and the like having a dimethylsiloxane or the like as a main constitutional unit.

The vinyl group-containing silicone resin is preferably a compound represented by formula (1) below.

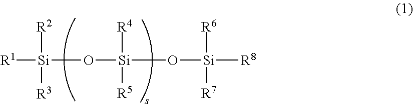

In formula (1), R¹ and R⁸ are each independently an alkyl group having 1 to 8 carbon atoms, an alkenyl group or a hydroxy group, preferably an alkenyl group, and more preferably a vinyl group.

R² to R⁷ are methyl groups or phenyl groups, and preferably methyl groups.

s is 60 to 3,000, preferably 80 to 2,500, more preferably 100 to 2,500, and further preferably 200 to 2,500.

The mass ratio of the vinyl group-containing silicone resin and the polysiloxane compound in the resin composition of this embodiment [the vinyl group-containing silicone resin/the polysiloxane compound] is, in view of obtaining a cured product having more appropriate hardness, preferably 88/12 or less, more preferably 86/14 or less, and further preferably 84/16, and is, in view of lowering the viscosity immediately after production, preferably 55/45 or more, more preferably 60/40 or more, and further preferably 65/35 or more. Specifically, the mass ratio of the vinyl group-containing silicone resin and the polysiloxane compound in the resin composition is preferably 55/45 or more and 88/12 or less, more preferably 60/40 or more and 86/14 or less, and further preferably 65/35 or more and 84/16 or less.

One vinyl group-containing silicone resin may be used singly, and two or more thereof may be mixed and then used.

### (Polysiloxane Compound)

The polysiloxane compound of this embodiment has at least one hydroxy group at an end, has no vinyl group, and has a weight-average molecular weight (Mw) in terms of polystyrene of 10,000 or more and 20,000 or less as measured by gel permeation chromatography (GPC). Note that the polysiloxane compound of this embodiment does not have any vinyl group not only at ends, but also in the main chain constituting the polysiloxane compound.

When the polysiloxane compound has a weight-average molecular weight (Mw) of 10,000 or more, the polysiloxane compound is not easily volatilized, foaming at the time of production of a thermally conductive composition can be suppressed, and a cured product having good appearance can be obtained. Moreover, when the polysiloxane compound has a weight-average molecular weight (Mw) of 20,000 or less, the resulting viscosity is not too high, the polysiloxane compound can be filled to a high degree with a thermally conductive filler, and thus high thermal conductivity can be imparted. Further, the thus obtained cured product is not too hard and has appropriate hardness.

The polysiloxane compound is not particularly limited, as long as it has at least one hydroxy group at an end, has no vinyl group, and has a weight-average molecular weight (Mw) of 10,000 or more and 20,000 or less. In view of lowering the viscosity immediately after production and obtaining a cured product having more appropriate hardness, the polysiloxane compound preferably has no silanol group, and has at least two hydroxy groups at one of the ends of the main chain constituting the polysiloxane compound. Moreover, from the same viewpoint, the polysiloxane compound preferably has the hydroxy group(s) not directly bound to a silicon atom, and more preferably does not have any hydroxy group that is not directly bound to a silicon atom and is located at the other end differing from the end at which a hydroxy group(s) not directly bound to a silicon atom is located. Specifically, the polysiloxane compound preferably has at least one hydroxy group at one of the ends of the main chain constituting the polysiloxane compound, which is not directly bound to a silicon atom, and has no hydroxy group at the other end, which is not directly bound to a silicon atom. The polysiloxane compound more preferably has at least two hydroxy groups that are not directly bound to a silicon atom and located at one of the ends of the main chain, and has no hydroxy group that is not directly bound to a silicon atom and located at the other end.

When the polysiloxane compound has a weight-average molecular weight (Mw) of less than 10,000, foaming takes place more easily at the time of production of a thermally conductive composition. When the polysiloxane compound has a weight-average molecular weight (Mw) of more than 20,000, the resulting viscosity is high, filling to a high degree with a thermally conductive filler becomes difficult, and the thus obtained cured product is excessively hard. In view of more suppressing foaming, the weight-average molecular weight (Mw) of the polysiloxane compound is preferably 11,000 or more, more preferably 12,000 or more, and further preferably 13,000 or more. In view of filling to a high degree with a thermally conductive filler and in view of obtaining a cured product having appropriate hardness, the weight-average molecular weight (Mw) of the polysiloxane compound is preferably 19,000 or less, more preferably 18,000 or less, and further preferably 17,000 or less. Specifically, the polysiloxane compound has a weight-average molecular weight (Mw) of preferably 11,000 or more and 19,000 or less, more preferably 12,000 or more and 18,000 or less, and further preferably 13,000 or more and 17,000 or less.

In an aspect of this embodiment, the polysiloxane compound is preferably a compound represented by general formula (2) below.

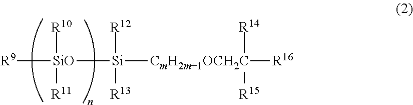

In formula (2), R⁹ is an alkyl group having 1 to 18 carbon atoms, or a phenyl group, R¹⁰ to R¹³ are each independently an alkyl group having 1 to 18 carbon atoms, or a phenyl group, R¹⁴ and R¹⁵ are each independently a hydrogen atom, hydroxymethyl group, or a hydroxyethyl group, R¹⁶ is an alkyl group having 1 to 3 carbon atoms, a hydroxy group, or a phenyl group, n is 5 to 250, and m is an integer of 1 to 20. When there are a plurality of R¹⁰ above and R¹¹ above, the plurality of R and R¹¹ are the same or different.

R⁹ is preferably an alkyl group having 1 to 18 carbon atoms, more preferably an alkyl group having 1 to 10 carbon atoms, further preferably an alkyl group having 1 to 5 carbon atoms, and even more preferably a butyl group, in view of lowering the viscosity immediately after production and obtaining a cured product having more appropriate hardness.

R¹⁰ to R¹³ are each independently preferably an alkyl group having 1 to 18 carbon atoms, more preferably an alkyl group having 1 to 10 carbon atoms, further preferably an alkyl group having 1 to 5 carbon atoms, and even more preferably a methyl group, in view of lowering the viscosity immediately after production and obtaining a cured product having more appropriate hardness.

R¹⁴ and R¹⁵ are each independently preferably a hydroxymethyl group, or a hydroxyethyl group, and more preferably a hydroxymethyl group, in view of lowering the viscosity immediately after production and obtaining a cured product having more appropriate hardness.

R¹⁶ is preferably an alkyl group having 1 to 3 carbon atoms, and more preferably an ethyl group, in view of lowering the viscosity immediately after production and obtaining a cured product having more appropriate hardness.

n is preferably 50 to 250 and more preferably 60 to 230 in view of lowering the viscosity immediately after production and obtaining a cured product having more appropriate hardness.

m is preferably 1 to 20, and more preferably 1 to 10 in view of lowering the viscosity immediately after production and obtaining a cured product having more appropriate hardness.

### <Thermally Conductive Filler>

The content of the thermally conductive filler in the thermally conductive composition of this embodiment ranges from 300 parts by mass to 5,000 parts by mass with respect to 100 parts by mass of the resin composition. In view of obtaining a thermally conductive composition having higher thermal conductivity, the content of the thermally conductive filler in the thermally conductive composition is preferably 500 parts by mass or more, more preferably 600 parts by mass or more, and further preferably 700 parts by mass or more with respect to 100 parts by mass of the resin composition. In view of kneading and mixing uniformly the thermally conductive filler with the resin composition containing the vinyl group-containing silicone resin, the content of the thermally conductive filler in the thermally conductive composition is preferably 4,000 parts by mass or less, more preferably 3,000 parts by mass or less, and further preferably 2,000 parts by mass or less. Specifically, the content of the thermally conductive filler in the thermally conductive composition is preferably 500 parts by mass or more and 4,000 parts by mass or less, more preferably 600 parts by mass or more and 3,000 parts by mass or less, and further preferably 700 parts by mass or more and 2,000 parts by mass or less with respect to 100 parts by mass of the resin composition.

The thermally conductive filler to be used in this embodiment has a function of transferring heat generated by electronic devices etc., to the outside of the system and examples thereof include metal, metal nitride, metal oxide, metal carbide, and metal hydroxide. The thermally conductive filler may be used singly or in combination of two or more types thereof.

The thermally conductive filler is preferably metal nitride or metal oxide in view of high thermal conductivity and insulation property, and metal nitride and metal oxide may also be used in combination.

Examples of metal nitride include boron nitride, aluminum nitride, and silicon nitride. Of these, aluminum nitride is preferable in view of high thermal conductivity and high ability to fill a resin.

Examples of metal oxide include such as zinc oxide, alumina, magnesium oxide, silicon dioxide, and iron oxide. Of these, alumina is preferable in view of high thermal conductivity, a lineup of various granularities, and a high degree of freedom for combination with metal nitride.

The particle size at a cumulative volume of 50% (hereinafter, denoted as D50) in the particle size distribution of the thermally conductive filler measured by the laser diffraction light-scattering method is preferably 0.2 μm or more and 200 μm or less, more preferably 0.5 μm or more and 100 μm or less, and further preferably 1.0 μm or more and 50 μm or less in view of adjustment of the thickness of a thermal conductive material, and handleability upon kneading a resin composition with the thermally conductive filler.

D50 of the thermally conductive filler can be measured by a grading analyzer, and specifically measured according to a method described in Examples.

The thermally conductive filler has preferably a hydroxy group. When the thermally conductive filler has a hydroxy group, the hydroxy group interacts with a hydroxy group(s) of the polysiloxane compound, because of intermolecular force, hydrogen bonding, and the like, the interaction between thermally conductive fillers via hydroxy groups is lowered in association therewith, the viscosity of the resin composition is even lowered, and thus, a cured product having appropriate hardness will be more easily obtained.

### (Aluminum Nitride)

Known products such as commercially available aluminum nitride products can be used. Aluminum nitride may be obtained by any production method such as a direct nitriding method that involves directly reacting metal aluminum powder with nitrogen or ammonia, and a reduction nitriding method that involves performing carbothermic reduction of alumina simultaneously with a nitriding reaction that is performed by heating in a nitrogen or ammonia atmosphere.

The shape of aluminum nitride is not particularly limited, and examples thereof include amorphous (crushed), spherical, ellipsoidal, and platy (flaky) shapes.

Further, the particle size at a cumulative volume of 50% (D50) in the particle size distribution of aluminum nitride as measured by the laser diffraction light-scattering method is preferably 0.2 μm or more and 200 μm or less, more preferably 10 μm or more and 100 μm or less, and further preferably 10 μm or more and 50 μm or less.

Aluminum nitride preferably has a silicon-containing oxide film on its surface in view of improving the moisture resistance. Specifically, surface-treated aluminum nitride is preferable. The silicon-containing oxide film may partially or entirely cover the surface of aluminum nitride, and preferably covers the entire surface of aluminum nitride.

Since aluminum nitride has excellent thermal conductivity, aluminum nitride having a silicon-containing oxide film on its surface (hereinafter also referred to as silicon-containing oxide-coated aluminum nitride) also has excellent thermal conductivity.

Examples of the “silicon-containing oxide” of the silicon-containing oxide film and silicon-containing oxide-coated aluminum nitride particles include silica and an oxide containing silicon and aluminum.

Regarding the silicon-containing oxide-coated aluminum nitride, the coverage with the silicon-containing oxide film covering the surface of the aluminum nitride is preferably 70% or more and 100% or less, more preferably 70% or more and 95% or less, further preferably 72% or more and 90% or less, and particularly preferably 74% or more and 85% or less as determined by LEIS analysis. When the coverage is 70% or more and 100% or less, the resulting moisture resistance is more excellent. Further, when the coverage exceeds 95%, the thermal conductivity may decrease.

The coverage (%) of a silicon-containing oxide film (SiO₂) covering the surface of aluminum nitride as determined by LEIS (Low Energy Ion Scattering) analysis is found by the following formula.

(S_{Al}(AlN)-S_{Al}(AlN+SiO₂))/S_{Al}(AlN)×100

In the above formula, S_{Al}(AlN) is the area of the Al peak of aluminum nitride, and S_{Al}(AlN+SiO₂) is the area of the Al peak of the silicon-containing oxide-coated aluminum nitride. The area of the Al peak can be determined by low energy ion scattering (LEIS) analysis, which is a measurement method using an ion source and a rare gas as probes. LEIS is an analysis technique in which rare gas of several keV is used as incident ions and is an evaluation technique that enables compositional analysis of the outermost surface (reference literature: The TRC News 201610-04 (October 2016)).

An example of the method for forming a silicon-containing oxide film on the surface of aluminum nitride is a method that involves a first step of covering the surface of aluminum nitride with a siloxane compound having a structure represented by formula (3) below, and a second step of heating the aluminum nitride covered with the siloxane compound at a temperature of 300° C. or higher and 800° C. or lower.

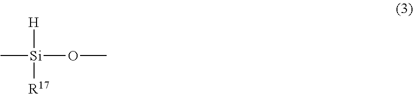

In formula (3), R¹⁷ is an alkyl group having 4 or less carbon atoms.

The structure represented by formula (3) is a hydrogen siloxane structural unit having a Si—H bond. In formula (3), R¹⁷ is an alkyl group having 4 or less carbon atoms, that is, a methyl group, an ethyl group, a propyl group, or a butyl group, and is preferably a methyl group, an ethyl group, an isopropyl group, or a t-butyl group, and more preferably a methyl group.

The siloxane compound is preferably an oligomer or a polymer containing the structure represented by formula (3) as a repeating unit. Further, the siloxane compound may be linear, branched, or cyclic. The weight-average molecular weight of the siloxane compound ranges from preferably 100 to 2,000, more preferably 150 to 1,000, and further preferably 180 to 500, in view of the ease of forming a silicon-containing oxide film with uniform thickness. The weight-average molecular weight is a value in terms of polystyrene as measured by gel permeation chromatography (GPC).

The siloxane compound that is suitably used is the compound represented by formula (4) below and/or the compound represented by formula (5) below.

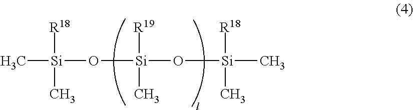

In formula (4), R¹⁸ and R¹⁹ are each independently a hydrogen atom or a methyl group, at least one of R¹⁸ and R¹⁹ is a hydrogen atom, 1 is an integer of 0 to 10, preferably 1 to 5, and more preferably 1.

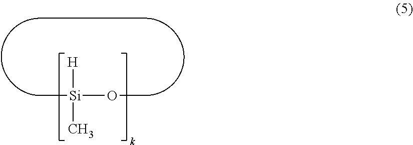

In formula (5), k is an integer of 3 to 6, preferably 3 to 5, and more preferably 4.

The siloxane compound is particularly preferably a cyclic hydrogen siloxane oligomer with n being 4 in formula (5) in view of the ease of forming a good silicon-containing oxide film.

In the first step, the surface of aluminum nitride is covered with a siloxane compound having the structure represented by formula (3) above.

In the first step, the method thereof is not particularly limited, as long as the surface of aluminum nitride can be covered with a siloxane compound having the structure represented by formula (3) above. An example of the method of the first step is a dry mixing method that involves adding the siloxane compound by spraying or the like under stirring aluminum nitride as a raw material using a general powder mixing device, followed by dry mixing for coating.

Examples of the powder mixing device include ribbon blenders having mixing impellers such as a Henschel mixer (available from NIPPON COKE & ENGINEERING CO., LTD.), a vessel rotating V-blender, and a double cone blender, screw blenders, closed rotary kilns, and stirring with a stirrer in a closed container using a magnetic coupling. The temperature condition is not particularly limited, but the temperature ranges from preferably 10° C. or higher and 200° C. or lower, more preferably 20° C. or higher and 150° C. or lower, and further preferably 40° C. or higher and 100° C. or lower.

It is also possible to use a vapor-phase adsorption method that involves depositing or vapor-depositing the vapor of the siloxane compound alone or a mixed gas with an inert gas such as a nitrogen gas on the surface of aluminum nitride that is left to stand. The temperature condition is not particularly limited, and the temperature ranges from preferably 10° C. or higher and 200° C. or lower, more preferably 20° C. or higher and 150° C. or lower, and further preferably 40° C. or higher and 100° C. or lower. Further, if necessary, the inside of the system can be pressurized or decompressed. As a device that can be used in this case, a closed device that can easily replace the gas inside the system is preferable, and for example, a glass container, a desiccator, a CVD device or the like can be used.

The amount of the siloxane compound to be used in the first step is not particularly limited. In the aluminum nitride covered with the siloxane compound to be obtained in the first step, the amount of the siloxane compound applied for coating ranges from preferably 0.1 mg or more and 1.0 mg or less, more preferably 0.2 mg or more and 0.8 mg or less, and ranges from further preferably 0.3 mg or more and 0.6 mg or less, per 1 m² of the surface area calculated from the specific surface area (m²/g) of the aluminum nitride as determined by the BET method. When the amount of the siloxane compound applied for coating is within such a range, aluminum nitride having a silicon-containing oxide film with uniform thickness can be obtained.

The amount of the siloxane compound applied for coating per 1 m² of the surface area calculated from the specific surface area (m²/g) of the aluminum nitride as determined by the BET method can be found by dividing a difference between the mass of the aluminum nitride before and that of the same after coating with the siloxane compound by the surface area (m²) calculated from the specific surface area (m²/g) of the aluminum nitride as determined by the BET method.

The specific surface area determined by the BET method can be measured from the single-point BET nitrogen adsorption based on the gas flow method. As an evaluation device, Macsorb HM model-1210, available from Mountech Co., Ltd., can be used.

In the second step, the aluminum nitride covered with the siloxane compound obtained in the first step is heated at a temperature of 300° C. or higher and 850° C. or lower. This makes it possible to form a silicon-containing oxide film on the surface of aluminum nitride. The heating temperature is more preferably 400° C. or higher, and further preferably 500° C. or higher.

The heating time ranges from preferably 30 minutes or more and 6 hours or less, more preferably 45 minutes or more and 4 hours or less, further preferably 1 hour or more and 2 hours or less, in view of ensuring a sufficient reaction time and efficiently forming a good silicon-containing oxide film.

The atmosphere during the heat treatment is preferably an atmosphere containing oxygen gas, for example, the atmosphere (in-air).

The silicon-containing oxide-coated aluminum nitride particles after the heat treatment in the second step may be in a partially fused state, but in such a case, it is de-agglomerated, for example, using a general grinder such as a roller mill, a hammer mill, a jet mill, and a ball mill, so that a silicon-containing oxide-coated aluminum nitride without sticking and agglomeration can be obtained.

Further, after the completion of the second step, the first step and the second step may be further sequentially performed. That is, the process of sequentially performing the first step and the second step may be repeated.

### (Alumina)

Alumina has thermal conductivity and is excellent in moisture resistance. As alumina, α-alumina (α-Al₂O₃) is preferable. Other than α-alumina, γ-alumina, θ-alumina, δ-alumina and the like may also be included.

Known products such as commercially available alumina products can be used. Known alumina such as commercially available products having a wide variety of types in terms of such as particle size and shape and being the most suitable can be selected, and is also inexpensive.

Alumina may be produced by any method, such as a thermal decomposition method for ammonium alum, a thermal decomposition method for ammonium aluminum carbonate, an underwater spark discharge method for aluminum, a gas-phase oxidation method, and a hydrolysis method for aluminum alkoxide.

The shape of alumina is not particularly limited, and examples thereof include amorphous (crushed), spherical, rounded, and polyhedral shapes.

Further, the particle size at a cumulative volume of 50% (D50), in the particle size distribution of alumina as measured by the laser diffraction light-scattering method is not particularly limited and is preferably 0.1 μm or more and 50 μm or less.

For example, in the case of alumina, surface treatment is preferably performed for alumina in view of obtaining a cured product having more appropriate hardness. Example of a surface treatment method is a method that involves treating the surface of alumina using a silane coupling agent. Examples of the silane coupling agent include butyltrimethoxysilane, hexyltrimethoxysilane, octyltrimethoxysilane, decyltrimethoxysilane, and hexadecyltrimethoxysilane. Of these, octyltrimethoxysilane, decyltrimethoxysilane, and hexadecyltrimethoxysilane are preferable and decyltrimethoxysilane is more preferable in view of obtaining a cured product having more appropriate hardness.

The silane coupling agent may be used singly or in combination of two or more types thereof.

The amount of a silane coupling agent to be used is preferably 0.01 parts by mass or more and 10 parts by mass or less, more preferably 0.02 parts by mass or more and 5 parts by mass or less with respect to 100 parts by mass of alumina. Through the use of the amount of a silane coupling agent within the above range, the surface of alumina can be sufficiently treated.

A typical method for treating alumina with a silane coupling agent is a dry mixing method that involves adding the silane coupling agent by spraying or the like under stirring alumina as a raw material using a general powder mixing device, followed by dry mixing.

Examples of the powder mixing device include a Henschel mixer (available from NIPPON COKE & ENGINEERING CO., LTD.) and a SPARTAN granulator (available from DALTON CORPORATION).

When alumina is treated with a silane coupling agent as described above, heat treatment is preferably performed at a temperature ranging from 100° C. to 140° C. for 1 to 5 hours after mixing, and more preferably performed at a temperature ranging from 110° C. to 130° C. for 2 to 4 hours after mixing.

The total content of aluminum nitride and alumina contained in the thermally conductive filler is preferably 90 mass % or more, more preferably 95 mass % or more, and particularly preferably 100 mass % in view of increasing the thermal conductivity.

The thermally conductive filler that may be used herein is composed of those having different particle sizes. For example, when the filler is composed of alumina having a small particle size (e.g., D50 is 0.1 μm or more and 50 μm or less) and aluminum nitride having a particle size larger than that of alumina (e.g., D50 is 10 μm or more and 100 μm or less), the amount of thermally conductive powder used for filling (mass %) in the thermally conductive composition can be increased, and thus the thermal conductivity of the thermally conductive composition can be more increased.

The content of the thermally conductive filler is preferably 70.0 mass % or more and 99.0 mass % or less, more preferably 75.0 mass % or more and 99.0 mass % or less, and further preferably 80 mass % or more and 98 mass % or less with respect to the total amount of the thermally conductive composition of this embodiment. When the content of the thermally conductive powder is 70.0 mass % or more, the thermal conductivity of the thermally conductive composition can be increased, and when the content of the same is 99.0 mass % or less, the thermally conductive filler can be kneaded and mixed with a vinyl group-containing silicone resin.

In addition to the aforementioned components, the thermally conductive composition of this embodiment can contain additives such as a cross-linking agent, a reaction accelerator, a retarder, a heat resistant agent, a flame retardant, a pigment, a flexibility-imparting agent, an inorganic ion scavenger, a pigment, a dye, and a diluent as required, as long as the effects of the present invention are not inhibited.

The content of an additive(s) in the thermally conductive composition is preferably 0 part by mass or more and 200 parts by mass or less with respect to 100 parts by mass of the resin composition of this embodiment.

The content of an additive(s) in the thermally conductive composition is preferably 0 mass % or more and 20 mass % or less with respect to the total amount of the thermally conductive composition of this embodiment.

### <Cross-linking Agent>

The thermally conductive composition of this embodiment may contain a cross-linking agent in view of obtaining a cured product having more appropriate hardness.

The thermally conductive composition of this embodiment contains a vinyl group-containing silicone resin, and thus it preferably contains an organic peroxide as a cross-linking agent.

Examples of the organic peroxide include benzoyl peroxide, 2,4-dichlorobenzoyl peroxide, p-methylbenzoyl peroxide, o-methylbenzoyl peroxide, 2,4-dicumyl peroxide, 2,5-dimethyl-bis(2,5-t-butylperoxy)hexane, di-t-butyl peroxide, t-butyl perbenzoate, and 1,1-bis(t-butylperoxy carboxy)hexane.

Of these, benzoyl peroxide, 2,4-dichlorobenzoyl peroxide, p-methylbenzoyl peroxide, and o-methylbenzoyl peroxide are preferable in view of the possibility of extruding.

Examples of a cross-linking agent other than an organic peroxide include polydimethylhydrosiloxane having a silicon-hydrogen bond, and include trialkoxysilane and dialkoxysilane represented by a silane coupling agent having two or more alkoxy groups.

Examples of a cross-linking agent other than an organic peroxide include the cross-linking agent represented by formula (6) below.

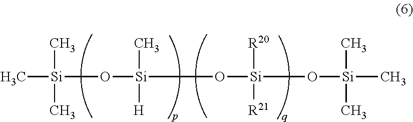

In formula (6), R²⁰ and R²¹ are each independently an alkyl group having 1 to 8 carbon atoms or a phenyl group, and more preferably a methyl group.

p is 0 to 1,000, q is 0 to 100, and p/q is preferably 0 to 100.

Cross-linking agents may be used singly, or in combinations of two or more thereof.

The content of a cross-linking agent in the thermally conductive composition is preferably 0.001 mass % or more and 10 mass % or less, more preferably 0.01 mass % or more and 5 mass % or less, further preferably 0.1 mass % or more and 1 mass % or less with respect to the total amount of the thermally conductive composition of this embodiment.

### <Reaction Accelerator>

The thermally conductive composition of this embodiment may contain a reaction accelerator.

Examples of the reaction accelerator include an amine compound and an organic cobalt acid.

Platinic chloride, alcohol-modified platinum, siloxane-modified platinum, or the like may be added as a flame retardant.

The content of the reaction accelerator in the thermally conductive composition is preferably 0 part by mass or more and 1 part by mass or less with respect to 100 parts by mass of the resin composition of this embodiment.

The content of the reaction accelerator in the thermally conductive composition is preferably 0 mass % or more and 1 mass % or less with respect to the total amount of the thermally conductive composition of this embodiment.

The viscosity immediately after production of the thermally conductive composition of this embodiment is preferably 50 Pa·s or more and 5,000 Pa·s or less, more preferably 100 Pas or more and 4,500 Pas or less, and further preferably 150 Pa·s or more and 4,000 Pa·s or less.

The viscosity can be measured using a flow viscometer by a method according to JIS K7210:2014, specifically, by the method described in Examples.

### [Method for Producing Thermally Conductive Composition]

The method for producing the thermally conductive composition is not particularly limited. For example, the thermally conductive composition can be obtained by supplying the vinyl group-containing silicone resin, thermally conductive filler, and various additives to be added as required simultaneously or in divided portions to a dispersion/dissolution apparatus, and then mixing, dissolving, and kneading, while heating as required. Examples of the dispersion/dissolution apparatus include a mortar machine, a planetary mixer, a rotation/revolution mixer, a kneader, and a roll mill.

### [Cured Product of Thermally Conductive Composition]

The thermal conductivity of a cured product of the thermally conductive composition of this embodiment is 1.0 W/mK or more. In view of removing heat from a heating element, the thermal conductivity is preferably 2.0 W/mK or more, and further preferably 2.5 W/mK or more, and in view of viscosity; that is, coatability and workability, the thermal conductivity is preferably 10.0 W/mK or less, more preferably 8.0 W/mK or less, and further preferably 7.0 W/mK or less. Specifically, the thermal conductivity of a cured product of the thermally conductive composition is preferably 1.0 W/mK or more and 10.0 W/mK or less, more preferably 2.0 W/mK or more and 8.0 W/mK or less, and further preferably 2.5 W/mK or more and 7.0 W/mK or less.

A cured product of the thermally conductive composition has an A hardness of preferably 20 or more and 100 or less, more preferably 40 or more and 98 or less, and further preferably 50 or more and 96 or less as measured according to the hardness test (type A) of JIS K7312:1996. With the A hardness within the above range, a cured product having appropriate hardness can be obtained.

The A hardness can be specifically measured by the method described in Examples.

### [Method for Producing Cured Product of Thermally Conductive Composition]

A cured product of the thermally conductive composition of this embodiment can be obtained by reacting at room temperature (25° C.) or by heating. When the thermally conductive composition is cured by heating, primary vulcanization is performed under conditions of a temperature of 50° C. or higher and 150° C. or lower, preferably a temperature of 60° C. or higher and 120° C. or lower, and 5 minutes or more and 2 hours or less, preferably 10 minutes or more and 1 hour or less, subsequently, secondary vulcanization is preferably performed under conditions of a temperature of 100° C. or higher and 250° C. or lower, preferably 150° C. or higher and 230° C. or lower, and 1 hour or more and 10 hours or less, preferably 2 hours or more and 6 hours or less. In addition, when primary vulcanization is performed, it is preferably performed under conditions of a pressure ranging from 0.1 MPa to 1.0 MPa.

The thermally conductive composition of this embodiment exhibits low viscosity immediately after production, and enables to obtain a cured product having appropriate hardness, so that the thermally conductive composition can be suitably used for electronic devices such as batteries, semiconductors, exothermic transformers, and coils, heater elements such as parts of a heater, which are countermeasures against heat dissipation, electronic instruments, personal computers, and automotive ECUs, etc.

### EXAMPLES

Next, the present invention is specifically described below by way of Examples. However, the present invention is not limited at all by Examples below.

### [Raw-material Compounds]

Details about raw-material compounds used in Production Examples A-1 and A-2, Production Example B-1, Examples 1 to 6, as well as comparative Examples 1 to 4 are as described below.

### (Metal Oxide (Thermally Conductive Filler))

Filler A-1(alumina): high-purity alumina AKP-30, available from SUMITOMO CHEMICAL COMPANY, LIMITED, average particle size: 0.3 μm, specific surface area (BET method): 7.0 m²/g

Filler A-2 (alumina): advanced alumina AA-03, available from SUMITOMO CHEMICAL COMPANY, LIMITED, average particle size: 3.0 μm, specific surface area (BET method): 0.5 m²/g

### (Alkoxysilane)

Alkoxysilane 1: Dynasylan(R)9116 (hexadecyltrimethoxysilane), EVONIK JAPAN CO., LTD.

### (Metal Nitride (Thermally Conductive Filler))

Filler B-1 (aluminum nitride): FAN-f80-A1, available from Furukawa Denshi Co., Ltd., average particle size: 76 μm, specific surface area (single-point BET method): 0.05 m²/g, granular

### (Siloxane Compound)

Siloxane compound 1 (D4H): 1,3,5,7-tetramethylcyclotetrasiloxane, Tokyo Chemical Industry Co., Ltd.

### (Vinyl Group-containing Silicone Resin)

Vinyl group-containing silicone resin 1: TSE201, available from Momentive Performance Materials Inc., weight-average molecular weight: 800,000, viscosity at 25° C.: 1,000,000 mPa·s or more and 3,000,000 mPa·s or less

### (Polysiloxane Compound)

Polysiloxane compound 1: the compound represented by formula (7) below (diol-terminated polysiloxane, n in formula (7) below is 5 to 250), weight-average molecular weight: 15,000, viscosity at 25° C.: 450 mPa·s

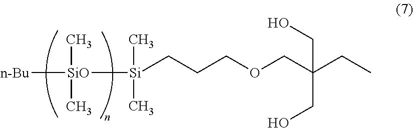

Polysiloxane compound 2: the compound represented by formula (7) above (diol-terminated polysiloxane, n is 5 to 250 in formula (7) above), weight-average molecular weight: 20,000, viscosity at 25° C.: 690 mPa·s

Polysiloxane compound 3: XF3905 (both-end hydroxy group-containing polysiloxane), available from Momentive Performance Materials Inc., weight-average molecular weight: 18,000, viscosity at 25° C.: 96.5 mPa·s

Polysiloxane compound 4: the compound represented by formula (7) above (diol-terminated polysiloxane, n is 5 to 250 in formula (7) above), weight-average molecular weight: 5,000, viscosity at 25° C.: 80 mPa·s to 160 mPa·s

Polysiloxane compound 5: KF96-500cs (dimethyl silicone oil having no hydroxy group at ends), Shin-Etsu Chemical Co., Ltd., weight-average molecular weight: 17,300, viscosity at 25° C.: 96.5 mPa·s

### (Organic Peroxide)

Vulcanizing agent (curing agent): TC-1 (benzoyl peroxide), available from Momentive Performance Materials Inc.

### (Additive)

KN320 (ferrosoferric oxide, pigment), available from TODA KOGYO CORPORATION

### [Surface Treatment of Thermally Conductive Filler]

Thermally conductive metal oxide fillers (Fillers A-1 and A-2), and thermally conductive metal nitride filler (filler B-1) were subjected to surface treatment.

The average particle size and the specific surface area of the above metal oxide and the above metal nitride were measured by the following measurement method.

### (1) Average Particle Size

The average particle size was found from the particle size (50% particle size D50) at which cumulative volume was 50% in the particle size distribution measured using a laser diffraction particle size distribution analyzer (available from MicrotracBEL Corp. product name: MT3300EXII).

The term “volume cumulative particle size D50” used herein refers to a particle size, at which the volume cumulative (integrated) value is 50% with respect to a particle size distribution, and is the value found from the particle size (50% particle size D50), at which the cumulative volume was 50% in the particle size distribution measured using the laser diffraction particle size distribution analyzer.

### (2) Specific Surface Area

The specific surface area was measured by single-point BET nitrogen adsorption using a specific surface area measuring device (available from Mountech Co., Ltd., product name: Macsorb MS30).

### <Surface Treatment of Metal Oxide>

Surface treatment of metal oxide was performed as described in Production Examples A-1 and A-2 below.

### (Production Example A-1>

100 parts by mass of filler A-1 was multiplied by the specific surface area of filler A-1, the product was divided by the minimum coating area (226 m²/g) of alkoxysilane 1 to give 3.10 parts by mass, 1.55 parts by mass of alkoxysilane 1 was weighed and added as the content of alkoxysilane 1,5 parts by mass of ethanol was added with respect to 100 parts by mass of filler A-1, water was then added in an amount (1.55 parts by mass) half the value obtained by multiplying 100 parts by mass of the filler A-1 by the specific surface area of filler A-1 and then dividing the product by the minimum coating area of alkoxysilane 1, to obtain a chemical agent, and then the chemical agent was added to filler A-1. The mixture was then stirred and mixed using a rotation/revolution mixer (available from THINKY CORPORATION, product name: ARV-310P) at a rotational speed of 1,000 rpm for 30 seconds, followed by loosening. This operation was repeated four times and then the resultant was air-dried once. Next, the resultant was heated in a hot air circulating oven at a temperature of 120° C. for 2 hours and then cooled, thereby obtaining treated filler A-1, the surface of which had been treated with alkoxysilane 1.

### (Production Example A-2>

Except for using filler A-2 instead of filler A-1, multiplying 100 parts by mass of filler A-2 by the specific surface area of filler A-2, dividing the product by the minimum coating area of alkoxysilane 1 (226 m²/g) to give 0.22 parts by mass, weighing and adding 0.12 parts by mass of alkoxysilane 1 as the content of alkoxysilane 1, adding 5 parts by mass of ethanol with respect to 100 parts by mass of filler A-2, and then adding water in an amount (0.11 parts by mass) half the value obtained by multiplying 100 parts by mass of filler A-2 by the specific surface area of filler A-2 and then dividing the product by the minimum coating area of alkoxysilane 1 to obtain a chemical agent, and then adding the chemical agent to filler A-2, treated filler A-2, the surface of which had been treated with alkoxysilane 1, was obtained in the same manner as in Production Example A-1.

### <Surface Treatment of Metal Nitride>

Surface treatment of metal nitride was performed in Production Example B-1.

### (Production Example B-1)

With the use of a vacuum desiccator that was made of acrylic resin with a plate thickness of 20 mm, had the internal dimensions of 260 mm×260 mm×100 mm, and had a structure vertically divided into three, the upper, the middle and the lower spaces, with the use of partitions having through holes, filler B-1 was spread uniformly in an amount of 200 g each over an aluminum stainless steel tray in the upper space and then left to stand. Next, in the lower space of the vacuum desiccator, 10 g of siloxane compound 1 put into a Petri dish made of glass was placed and left to stand. Thereafter, the vacuum desiccator was closed and heated in an oven at 80° C. for 30 hours. The operation was performed while taking safety countermeasures such that the hydrogen gas generated by the reaction was released through a release valve attached to the vacuum desiccator. Next, a sample taken out of the desiccator was put into a crucible made of alumina, and then filler B-1 with D4H adhered thereto was heated at 700° C. for 3 hours in the atmosphere, thereby obtaining silicon-containing oxide-coated aluminum nitrides, silicon-containing oxide-coated aluminum nitride B-1.

### Example 1

80 parts by mass of vinyl group-containing silicone resin 1, 20 parts by mass of polysiloxane compound 1, 200 parts by mass of treated filler A-1, 250 parts by mass of treated filler A-2, 2 parts by mass of additive (ferrosoferric oxide), and 5 parts by mass of organic peroxide (TC-1) were put into a rotation/revolution mixer (available from THINKY CORPORATION, product name: ARV-310P), and then stirred and mixed at a rotational speed of 2,000 rpm for 30 seconds under reduced pressure. Subsequently, the mixture was cooled to room temperature (25° C.), 400 parts by mass of silicon-containing oxide-coated aluminum nitride B-1 was added to the mixture, and then the mixture was stirred for defoaming at a rotational speed of 2,000 rpm for 30 seconds, thereby obtaining the thermally conductive composition of Example 1.

### Examples 2 to 5, and Comparative Examples 1 to 4

Except for changing the types and the amounts to be mixed of components as described in Table 1, the thermally conductive composition of each of Examples and Comparative Examples was obtained in the same manner as in Example 1.

Note that in Comparative Example 2, the polysiloxane compound had a weight-average molecular weight of less than 10,000, so that foaming took place during production of the thermally conductive composition and the appearance of the obtained cured product was poor.

Moreover, Examples 4 and 5 and Comparative Example 4, in which the thermally conductive fillers in the same system had been used, were compared. Since the polysiloxane compound having at least one hydroxy group at an end was not contained in Comparative Example 4, the viscosity of the composition was not sufficiently lowered, and filling with the thermally conductive filler (mixing with the thermally conductive filler) could not be performed.

### [Preparation of Test Piece (Cured Product)]

A 0.1-mm thick polyester film subjected to mold release treatment with fluorine was placed in a mold with a diameter of 45 mm and a thickness of 6 mm. The defoamed thermally conductive composition was poured into the mold without allowing aeration, and then a 0.1-mm thick polyester film was placed on the resultant without allowing aeration. The resultant was placed between aluminum plates, subjected to primary vulcanization with a press at 120° C. for 30 minutes at 0.5 MPa, and then subjected to secondary vulcanization in a hot air circulating oven at a temperature of 200° C. for 4 hours, thereby obtaining each test piece (diameter of 45 mm and thickness of 6 mm) of Example and Comparative Example.

### [Evaluation of Measurement]

The properties of the thermally conductive compositions and the test pieces; that is, the cured products thereof, obtained in each Example and Comparative Example were measured under measurement conditions shown below. Tables 1 to 5 show the results.

### (1) Viscosity

The viscosity of each thermally conductive composition immediately after production (up to 5 minutes after production) was measured according to JIS K7210:2014 using a flow viscometer (GFT-100EX, available from SHIMADZU CORPORATION) under conditions of a temperature of 30° C., a die hole diameter (diameter) of 1.0 mm and a test force of 40 (weight: 7.8 kg).

### (2) Hardness

Regarding test pieces that were cured products of the thermally conductive compositions, Asker A hardness was measured according to JIS K7312:1996 using a durometer (product name: ASKER Durometer Type A, available from KOBUNSHI KEIKI CO., LTD.).

### (3) Thermal Conductivity

The thermal conductivity of each of the above test pieces was measured according to ISO22007-2 by a hot-disk method using a thermophysical property measuring device (available from Kyoto Electronics Manufacturing Co., Ltd., product name TPS 2500 5).

### (4) Appearance of Cured Product

The appearance of a cured product was visually observed and evaluated according to the following criteria.
Good: A cured product had a smooth surface.
Poor: A cured product had surface irregularities due to foaming.

TABLE 1

| | | | | | Example | Example | Example | Comparative | Comparative |
|---|---|---|---|---|---|---|---|---|---|
| | | | | Unit | 1 | 2 | 3 | Example 1 | Example 2 |
| Composition | Resin | Vinyl | Vinyl group- | Parts | 80 | 80 | 80 | 100 | 80 |
| | composition | group- | containing | by | | | | | |
| | | containing | silicone | mass | | | | | |
| | | silicone resin | resin 1 | | | | | | |
| | | Polysiloxane | Polysiloxane | | 20 | — | — | — | — |
| | | compound | compound 1^{*1} | | | | | | |
| | | | Polysiloxane | | — | 20 | — | — | — |
| | | | compound 2^{*2} | | | | | | |
| | | | Polysiloxane | | — | — | 20 | — | — |
| | | | compound 3^{*3} | | | | | | |
| | | | Polysiloxane | | — | — | — | — | 20 |
| | | | compound 4^{*4} | | | | | | |
| | | | Polysiloxane | | — | — | — | — | — |
| | | | compound 5^{*5} | | | | | | |

| | | | | | | | |
|---|---|---|---|---|---|---|---|
| | Vinyl group-containing | — | 80/20 | 80/20 | 80/20 | — | — |
| | silicone resin/ | | | | | | |
| | Polysiloxane | | | | | | |
| | compound *6 | | | | | | |
| Thermally | Treated filler A-1 | Parts | 200 | 200 | 200 | 200 | 200 |
| conductive | Treated filler A-2 | by | 250 | 250 | 250 | 250 | 250 |
| filler | Silicon- | mass | 400 | 400 | 400 | 400 | 400 |
| | containing oxide- | | | | | | |
| | coated aluminum | | | | | | |
| | nitride B-1 | | | | | | |
| | Total content | | 850 | 850 | 850 | 850 | 850 |
| Additive | Ferrosoferric oxide | | 2 | 2 | 2 | 2 | 2 |
| Organic | TC-1 | | 5 | 5 | 5 | 5 | 5 |
| peroxide | | | | | | | |

| | | | | | | | |
|---|---|---|---|---|---|---|---|
| Evaluation | Viscosity | Pa·s | 253 | 340 | 390 | 534 | 219 |
| | Hardness (Asker A hardness) | — | 85 | 87 | 96 | 91 | 83 |
| | Thermal conductivity | W/m·k | 3.04 | 3.06 | 3.06 | 3.05 | 3.03 |
| | Appearance of cured product | — | Good | Good | Good | Good | Poor |

| | | | | | Example | Example | Comparative | Comparative |
|---|---|---|---|---|---|---|---|---|
| | | | | Unit | 4 | 5 | Example 3 | Example 4 |
| Composition | Resin | Vinyl | Vinyl group- | Parts | 80 | 80 | 80 | 100 |
| | composition | group- | containing | by | | | | |
| | | containing | silicone | mass | | | | |
| | | silicone resin | resin 1 | | | | | |
| | | Polysiloxane | Polysiloxane | | 20 | — | — | — |
| | | compound | compound 1^{*1} | | | | | |
| | | | Polysiloxane | | — | 20 | — | — |
| | | | compound 2^{*2} | | | | | |
| | | | Polysiloxane | | — | — | — | — |
| | | | compound 3^{*3} | | | | | |
| | | | Polysiloxane | | — | — | — | — |
| | | | compound 4^{*4} | | | | | |
| | | | Polysiloxane | | — | — | 20 | — |
| | | | compound 5^{*5} | | | | | |

| | | | | | | |
|---|---|---|---|---|---|---|
| | Vinyl group-containing | — | 80/20 | 80/20 | — | — |
| | silicone resin/ | | | | | |
| | Polysiloxane | | | | | |
| | compound *6 | | | | | |
| Thermally | Treated filler A-1 | Parts | 300 | 300 | 300 | 300 |
| conductive | Treated filler A-2 | by | 375 | 375 | 375 | 375 |
| filler | Silicon- | mass | 600 | 600 | 600 | 600 |
| | containing oxide- | | | | | |
| | coated aluminum | | | | | |
| | nitride B-1 | | | | | |
| | Total content | | 1275 | 1275 | 1275 | 1275 |
| Additive | Ferrosoferric oxide | | 2 | 2 | 2 | 2 |
| Organic | TC-1 | | 5 | 5 | 5 | 5 |
| peroxide | | | | | | |

| | | | | | | |
|---|---|---|---|---|---|---|
| Evaluation | Viscosity | Pa·s | 3220 | 4050 | 5020 | |
| | Hardness (Asker A hardness) | — | 95 | 97 | 98 | — |
| | Thermal conductivity | W/m·k | 4.96 | 5.01 | 5.03 | — |
| | Appearance of cured product | — | Good | Good | Good | — |

^{*1}Polysiloxane compound having two hydroxy groups not directly bound to a silicon atom at an end and having no vinyl group
^{*2}Polysiloxane compound having two hydroxy groups not directly bound to a silicon atom at an end and having no vinyl group
^{*3}Polysiloxane compound having one hydroxy group not directly bound to a silicon atom at each of both ends, and having no vinyl group
^{*4}Polysiloxane compound having two hydroxy groups not directly bound to a silicon atom at an end and having no vinyl group
^{*5}Polysiloxane compound having no hydroxy group at an end and having no vinyl group (dimethyl silicone oil)
^{*6}Polysiloxane compound having a weight-average molecular weight (Mw) of 10,000 or more and 20,000 or less, having at least one hydroxy group not directly bound to a silicon atom at an end, and having no vinyl group

Comparison of Examples and Comparative Examples reveals that the thermally conductive composition contains the polysiloxane compound having a hydroxy group at an end, so that the viscosity immediately after production is low and a cured product having appropriate hardness is obtained.

1. A thermally conductive composition comprising a resin composition and a thermally conductive filler, wherein
the resin composition comprises a vinyl group-containing silicone resin having a viscosity ranging from 40,000 mPa·s to 200,000,000 mPa·s at 25° C. as measured according to JIS Z8803:2011 and a polysiloxane compound having at least one hydroxy group at an end, having no vinyl group, and having a weight-average molecular weight (Mw) in terms of polystyrene of 10,000 or more and 20,000 or less as measured by gel permeation chromatography (GPC),
the mass ratio of the vinyl group-containing silicone resin to the polysiloxane compound [the vinyl group-containing silicone resin/the polysiloxane compound] is 50/50 or more and less than 90/10,
the content of the thermally conductive filler ranges from 300 parts by mass to 5,000 parts by mass with respect to 100 parts by mass of the resin composition, and
a cured product of the thermally conductive composition has a thermal conductivity of 1.0 W/mk or more as measured according to ISO22007-2.

2. The thermally conductive composition according to claim 1, wherein the polysiloxane compound has two or more hydroxy groups, at one of the ends of the main chain constituting the polysiloxane compound.

3. The thermally conductive composition according to claim 1, comprising an organic peroxide.

4. The thermally conductive composition according to claim 1, wherein the polysiloxane compound is represented by general formula (2) below: 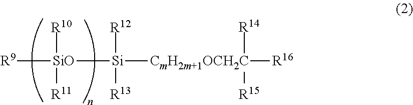
wherein R⁹ is an alkyl group having 1 to 18 carbon atoms, or a phenyl group, R¹⁰ to R¹³ are each independently an alkyl group having 1 to 18 carbon atoms, or a phenyl group, R¹⁴ and R¹⁵ are each independently a hydrogen atom, a hydroxymethyl group, or a hydroxyethyl group, R¹⁶ is an alkyl group having 1 to 3 carbon atoms, a hydroxy group, or a phenyl group, n is 5 to 250, m is an integer of 1 to 20, and when there are a plurality of R¹⁰ and R¹¹, the plurality of R¹⁰ and R¹¹ are the same or different.

5. The thermally conductive composition according to claim 4, wherein R⁹ is an alkyl group having 1 to 18 carbon atoms.

6. The thermally conductive composition according to claim 4, wherein R¹⁴ and R¹⁵ are each independently a hydroxymethyl group or a hydroxyethyl group.

7. The thermally conductive composition according to claim 1, wherein the content of the thermally conductive filler is 4,000 parts by mass or less with respect to 100 parts by mass of the resin composition.

8. The thermally conductive composition according to claim 1, wherein the vinyl group-containing silicone resin has a viscosity of 20,000,000 mPa·s or less at 25° C. as measured according to JIS Z8803:2011.

9. The thermally conductive composition according to claim 1, which is used for a heater element.
